(19) United States
(12) Patent Application Publication
(10) Pub. No.: US 2013/0061028 A1
(43) Pub. Date: Mar. 7, 2013

(54) Method and system for multi-mode instruction-level streaming

(71) Applicant: Harold Ishebabi, Vancouver (CA)

(72) Inventor: Harold Ishebabi, Vancouver (CA)

(73) Assignee: SECODIX CORPORATION, Vancouver (CA)

(21) Appl. No.: 13/593,207

(22) Filed: Aug. 23, 2012

(30) Foreign Application Priority Data
Sep. 1, 2011 (CA) 2751388

(51) Int. Cl. G06F 9/00

(52) U.S. Cl. 713/1

(57) ABSTRACT

The present invention relates to systems, apparatuses and methods for parallel computing of an application, by streaming instructions between cores, where the cores can execute more than one instruction during the course of the application.

### CROSS-REFERENCE TO RELATED APPLICATION

This patent application is based on and claims the benefit of priority from Canadian Patent Application Number 2,751,388, filed on Sep. 1, 2011, the contents of which are incorporated by reference in its entirety and assigned to the assignee of the present invention.

This patent application is related to co-pending U.S. patent application Ser. No. 12/729,131, filed Mar. 3, 2010, entitled “Reconfigurable Computing System and Method of Developing Application for Deployment on the Same”, the contents of which are incorporated by reference in its entirety and assigned to the assignee of the present invention.

### NOTICE REGARDING COPYRIGHTED MATERIAL

A portion of the disclosure of this patent document contains material which is subject to copyright protection. The copyright owner has no objection to the facsimile reproduction of the patent document or the patent disclosure as it appears in the Patent and Trademark Office file or records, but otherwise reserves all copyright rights whatsoever.

### FIELD OF THE INVENTION

The present invention relates to the field of parallel computing and, specifically, parallel execution using instruction level streaming.

### BACKGROUND

Parallel computing presents both key advantages and unique challenges. Following the old adage that two minds are better than one, parallel computing allows instructions to be executed or information to be processed in parallel, thus improving performance. At least theoretically, parallel computing promised to increase throughput by a factor equivalent to the number of parallel processors or cores used. For example, theoretically, a two core system was supposed to double performance. Practically, parallel computing has brought performance improvements that have been significantly below the theoretical maximum. The main reason for this is that concepts developed for single-core systems have proven to be poorly portable to parallel systems.

Programming languages are, for the most part, sequential. A programmer writing sequential code expects that operations will be executed in sequence. Concurrent or parallel languages, libraries, application programming interfaces (APIs), and programming models have been developed but, thus far, have achieved only marginal market penetration because of the tedious and error-prone manual parallelization process and lack of portability, many are designed for specific parallel systems or processors. For the most part, parallel programming has been limited to explicit parallelism or programming complete tasks or threads that are intended to run concurrently.

Automatic parallelization systems have also been experimented with, whereby ordinary sequential code is converted into multi-threaded and/or vectorized code to utilize multiple cores or processors simultaneously (see, for example, US 2010/0241827, by Yu et al.). Although quality of automatic parallelization algorithms continues to improve, they still suffer from substantial challenges including requirement for complex code analysis, which is inherently conservative and thus may miss potentially parallel structures, requirement for anticipation of unknown factors, such as input data, and lack of portability, as many are developed for specific systems or hardware architectures. Furthermore, in coarse grain task-based parallelism, they may be no guarantee that tasks will be executed on dedicated cores for multiple performance.

A number of hardware solutions have also been proposed which try to maximize performance by automatically directing execution to different cores to increase performance.

In US 2008/0162883, Luick describes an improvement on known pipelining architectures which consists of a cascaded execution arrangement where stalls (situations where a pipeline is empty) are reduced by utilizing a cascaded arrangement of pipelines with execution units that are delayed with respect to each other, and thus dependent instructions may be appropriately scheduled between the pipelines to be executed at different times. Results of execution can be forwarded from one pipeline to another. The arrangement described by Luick requires explicit scheduling of instructions and thus involves substantial overhead associated with the scheduling. Furthermore, scheduling instructions only within an issue window (a code block where instructions may be dependent) limits scalability.

In US 2009/0070552, Kanstein et al. describe a signal processing device adapted for processing at least two threads in a coarse-grained multi-processing manner. Each thread is programmed in software. However, explicit instruction and thread scheduling is used, thus limiting performance. Furthermore, the described system may require a programmer to be architecture-aware during development.

Another method of programming and operating parallel computing platforms is Instruction-Level Streaming (ILS) technology, which takes streaming (a process where data is taken from one execution entity to another for processing in a continuous manner) to the instruction level and allows software developers to achieve hardware-like performance while programming in widely known sequential programming languages such as C, C++, Java, etc.

In Single-Mode ILS (SM-ILS) technology, as described by Ishebabi in U.S. Ser. No. 12/729,131 (US Publication Number 2011/0231644), filed on Mar. 22, 2010, which is hereby incorporated by reference in its entirety and which is owned by a common assignee, an ILS compiler, or a generic compiler with an ILS API, extracts application graphs from source code written in a sequential programming language and maps the graphs onto a heterogeneous system of Ultra Simple Cores (USC) interconnected by a set of pathways between them. Instructions and information are then processed by the USCs and streamed between them via the pathways without further data movement, scheduling or other control instructions. The SM-ILS technology provides a substantial improvement over other methods of configuring, programming and/or operating parallel systems, such as multi-thread programming, branch prediction, pipelining, and speculative execution.

USCs used in SM-ILS technology can be implemented in fixed or reconfigurable technologies such as field-programmable gate arrays (FPGAs) and application-specific integrated circuits (ASICs), and they can be used with any instruction set processors such as general purpose processors (GPPs), graphics processing units (GPUs), and others. For the purposes of SM-ILS, throughout the execution of a particular application, each USC executes one specific atomic instruction or performs one discrete operation at each clock cycle. Throughout this description, the term instruction is used to include both atomic instructions and more complex operations. The system is heterogeneous and the USCs may differ in functionality and capabilities. The entire SM-ILS system can be implemented at chip-level (e.g., USCs and pathways within a single chip), board-level (e.g., USCs on a single board connected by physical pathways), or as loosely coupled discrete systems (a multitude of boards and/or discrete devices, interconnected by physical or logical pathways, e.g., the Internet). The particular system configuration, including the number and type of USCs and pathways used, is selected depending on the application that is being implemented. For example, whereas digital signal processing (DSP) may be implemented as an FPGA comprising a number of interconnected USCs, a distributed cryptographic system may be implemented as a loose network of diversely located devices, each functioning as a USC, interconnected via the Internet.

Once an application graph is extracted from source code, the graph is mapped onto the SM-ILS system by configuring each USC, either directly or through an intermediate entity, with the following parameters: (i) the instruction that the USC will perform; (ii) the location of the source operands—data which will be processed; (iii) the location of the destination operands—data that will be output; and (iv) when the instruction will be performed. Furthermore, where pathways are dynamic (e.g., packet-based network or the internet), the mapping process may also configure the connections between the USCs. The compiler does not configure the capabilities or the basic architecture of the ILS system, but it is aware of the capabilities and architecture of the system being used.

Once mapping is completed, data flows freely from one USC to another via the pathways in a streaming manner, without data-movement, scheduling or other control instructions issued by a central processor. In other words, each USC executes a pre-configured instruction and automatically passes the data onto the next USC, which is also pre-configured to execute an instruction on the date and to pass the result onwards. Once an application has finished executing, the ILS network may be reconfigured for another application.

The SM-ILS technology provides mechanisms for constructing arbitrary data paths on the USC networks described above from sequential code, effectively rendering application development for distributed and/or multi-processor systems as easy as modeling DSP chains in Matlab®, a numerical computing environment and fourth-generation programming language developed by MathWorks, Inc. of Natick, Mass.

Despite its advantages, the SM-ILS technology described in US 2011/0231644, is designed for a system where, once configured, each USC will only execute one particular instruction for the duration of the application. To cause the USC to execute a different instruction, the mapping has to be re-done and the system re-reconfigured.

However, some applications benefit from an ILS architecture in which USCs can execute more than one instruction during the course of the execution of the application. For example, multi-rate applications can achieve higher hardware utilizations if USCs can execute several different simpler instructions at a high rate, rather than one complex instruction at a lower rate. Another example is applications with feedback loops. Loops require the execution rate on USCs to be slowed to allow computed results to propagate up a graph. Allowing a USC to execute multiple instructions can lead to more efficient hardware utilization.

What is needed is a multi-core parallel computing system with the advantages of single-mode instruction level streaming, but where cores can execute more than one instruction during the course of the execution of an application.

### SUMMARY OF THE INVENTION

According to one aspect of the present invention, there is provided a method of configuring a plurality of ultra simple cores, comprising connecting each downstream one of the plurality of ultra simple cores to receive data streamed from a respective at least one upstream one of the plurality of ultra simple cores, the data including at least one of information and an instruction, the information being at least one of an operand and flow control information, wherein at least one of the downstream one of the plurality of ultra simple cores is connected to receive at least one of an instruction and flow control information streamed from the respective at least one upstream one of the plurality of ultra simple cores.

This could be a method wherein connecting includes connecting directly.

This could be a method wherein connecting includes connecting indirectly via a communication bus.

This could be a method wherein connecting includes providing local memory to the downstream one of the plurality of ultra simple cores to store received streamed data.

This could be a method wherein connecting includes providing a sequencer to the downstream one of the plurality of ultra simple cores to sequence received data.

This could be a method wherein providing a sequencer includes providing a sequencer to sequence received streamed data.

This could be a method wherein providing a sequencer includes providing a passive sequencer.

This could be a method wherein providing a sequencer includes providing an active sequencer.

This could be a method wherein providing an active sequencer includes providing a sequencer memory and an execution memory.

This could be a method wherein providing a sequencer includes connecting the sequencer to receive configuration data.

This could be a method wherein connecting includes providing delay buffers to the downstream one of the plurality of ultra simple cores to delay received streamed data.

This could be a method wherein connecting includes providing an execution unit to the downstream one of the plurality of ultra simple cores to execute received streamed data.

This could be a method wherein connecting includes connecting the execution unit to receive streamed data via the local memory.

This could be a method wherein connecting includes connecting the execution unit to receive streamed data via the local memory via the delay buffers.

This could be a method wherein connecting includes connecting the execution unit to receive streamed data via the local memory via the delay buffers via the local memory.

This could be a method wherein connecting includes connecting the execution unit to receive streamed data via the local memory via the sequencer.

This could be a method wherein connecting includes connecting the execution unit to receive streamed data via the local memory via the sequencer via the delay buffers.

This could be a method wherein connecting includes creating a feedback delay.

This could be a method wherein creating a feedback delay includes configuring the sequencer to direct the execution unit to a series of idle instructions.

This could be a method wherein creating a feedback delay includes configuring the sequencer to direct the execution unit to execute a plurality of instructions for a plurality of clock cycles.

This could be a method wherein configuring includes providing the plurality of ultra simple cores with a plurality of respective memory banks.

This could be a method wherein providing includes connecting one of the plurality of the ultra simple cores directly to its respective one of the plurality of memory banks.

This could be a method wherein providing includes connecting one of the plurality of the ultra simple cores indirectly to its respective one of the plurality of memory banks via a memory bus.

This could be a method wherein providing includes connecting one of the plurality of the ultra simple cores indirectly via another one of the plurality of the ultra simple cores to the respective one of the plurality of memory banks of the another one of the plurality of the ultra simple cores.

This could be a method further comprising connecting the plurality of ultra simple cores to exchange data with a base processor.

This could be a method further including connecting the plurality of ultra simple cores and the base processor to shared storage.

According to another aspect of the present invention, there is provided a product obtained by the above method.

According to another aspect of the present invention, there is provided a method of operating a plurality of ultra simple cores, comprising streaming to each downstream one of the plurality of ultra simple cores data from a respective at least one upstream one of the plurality of ultra simple cores, the data including at least one of information and an instruction, the information being at least one of an operand and flow control information, wherein at least one of the respective at least one upstream one of the plurality of ultra simple cores streams at least one of an instruction and flow control information.

This could be a method wherein streaming includes storing the streamed data at the downstream one of the plurality of ultra simple cores.

This could be a method further including at least one of executing the streamed data and executing upon the streamed data at the downstream one of the plurality of ultra simple cores.

This could be a method wherein storing includes sequencing the streamed data.

This could be a method further including at least one of executing the streamed data and executing upon the streamed data at the downstream one of the plurality of ultra simple cores.

This could be a method wherein storing includes delaying the streamed data.

This could be a method further including at least one of executing the streamed data and executing upon the streamed data at the downstream one of the plurality of ultra simple cores.

This could be a method wherein storing includes delaying the streamed data.

This could be a method further including at least one of executing the streamed data and executing upon the streamed data at the downstream one of the plurality of ultra simple cores.

This could be a method further including at least one of executing the streamed data and executing upon the streamed data at the downstream one of the plurality of ultra simple cores.

This could be a method wherein executing includes branching.

This could be a method wherein branching includes branching without interrupting the stream.

This could be a method wherein branching includes branching in response to an instruction in the streamed data.

This could be a method wherein branching includes branching in response to flow control information in the streamed data.

According to another aspect of the invention, there is provided a system for configuring a plurality of ultra simple cores, comprising means for connecting each downstream one of the plurality of ultra simple cores to receive data streamed from a respective at least one upstream one of the plurality of ultra simple cores, the data including at least one of information and an instruction, the information being at least one of an operand and flow control information, wherein at least one of the downstream one of the plurality of ultra simple cores is connected to receive at least one of an instruction and flow control information streamed from the respective at least one upstream one of the plurality of ultra simple cores.

This could be a system wherein the means for connecting includes means for connecting directly.

This could be a system wherein the means for connecting includes means for connecting indirectly via a communication bus.

This could be a system wherein the means for connecting includes means for providing local memory to the downstream one of the plurality of ultra simple cores to store received streamed data.

This could be a system wherein the means for connecting includes means for providing a sequencer to the downstream one of the plurality of ultra simple cores to sequence received data.

This could be a system wherein the means for providing a sequencer includes means for providing a sequencer to sequence received streamed data.

This could be a system wherein the means for providing a sequencer includes means for providing a passive sequencer.

This could be a system wherein the means for providing a sequencer includes means for providing an active sequencer.

This could be a system wherein the means for providing an active sequencer includes means for providing a sequencer memory and an execution memory.

This could be a system wherein the means for providing a sequencer includes means for connecting the sequencer to receive configuration data.

This could be a system wherein the means for connecting includes means for providing delay buffers to the downstream one of the plurality of ultra simple cores to delay received streamed data.

This could be a system wherein the means for connecting includes means for providing an execution unit to the downstream one of the plurality of ultra simple cores to execute received streamed data.

This could be a system wherein the means for connecting includes means for connecting the execution unit to receive streamed data via the local memory.

This could be a system wherein the means for connecting includes means for connecting the execution unit to receive streamed data via the local memory via the delay buffers.

This could be a system wherein the means for connecting includes means for connecting the execution unit to receive streamed data via the local memory via the delay buffers via the local memory.

This could be a system wherein the means for connecting includes means for connecting the execution unit to receive streamed data via the local memory via the sequencer.

This could be a system wherein the means for connecting includes means for connecting the execution unit to receive streamed data via the local memory via the sequencer via the delay buffers.

This could be a system wherein the means for connecting includes means for creating a feedback delay.

This could be a system wherein the means for creating a feedback delay includes means for configuring the sequencer to direct the execution unit to a series of idle instructions.

This could be a system wherein the means for creating a feedback delay includes means for configuring the sequencer to direct the execution unit to execute a plurality of instructions for a plurality of clock cycles.

This could be a system wherein the means for configuring includes means for providing the plurality of ultra simple cores with a plurality of respective memory banks.

This could be a system wherein the means for providing includes means for connecting one of the plurality of the ultra simple cores directly to its respective one of the plurality of memory banks.

This could be a system wherein the means for providing includes means for connecting one of the plurality of the ultra simple cores indirectly to its respective one of the plurality of memory banks via a memory bus.

This could be a system wherein the means for providing includes means for connecting one of the plurality of the ultra simple cores indirectly via another one of the plurality of the ultra simple cores to the respective one of the plurality of memory banks of the another one of the plurality of the ultra simple cores.

This could be a system further comprising means for connecting the plurality of ultra simple cores to exchange data with a base processor.

This could be a system further including means for connecting the plurality of ultra simple cores and the base processor to shared storage.

According to another aspect of the invention, there is provided a system having a plurality of ultra simple cores, comprising means for streaming to each downstream one of the plurality of ultra simple cores data from a respective at least one upstream one of the plurality of ultra simple cores, the data including at least one of information and an instruction, the information being at least one of an operand and flow control information, wherein at least one of the respective at least one upstream one of the plurality of ultra simple cores streams at least one of an instruction and flow control information.

This could be a system wherein the means for streaming includes means for storing the streamed data at the downstream one of the plurality of ultra simple cores.

This could be a system further including means for executing at least one of the streamed data and upon the streamed data at the downstream one of the plurality of ultra simple cores.

This could be a system wherein the means for storing includes means for sequencing the streamed data.

This could be a system further including means for executing at least one of the streamed data and upon the streamed data at the downstream one of the plurality of ultra simple cores.

This could be a system wherein the means for storing includes means for delaying the streamed data.

This could be a system further including means for executing at least one of the streamed data and upon the streamed data at the downstream one of the plurality of ultra simple cores.

This could be a system wherein the means for storing includes means for delaying the streamed data.

This could be a system further including means for executing at least one of the streamed data and upon the streamed data at the downstream one of the plurality of ultra simple cores.

This could be a system further including means for executing at least one of the streamed data and upon the streamed data at the downstream one of the plurality of ultra simple cores.

This could be a system wherein the means for executing includes means for branching.

This could be a system wherein the means for branching includes means for branching without interrupting the stream.

This could be a system wherein the means for branching includes means for branching in response to an instruction in the streamed data.

This could be a system wherein the means for branching includes means for branching in response to flow control information in the streamed data.

According to another aspect of the invention, there is provided a processor-readable medium encoding sequences of information and instructions which, when executed by a processor cause the processor to configure a plurality of ultra simple cores, the information and instructions comprising the steps of connecting each downstream one of the plurality of ultra simple cores to receive data streamed from a respective at least one upstream one of the plurality of ultra simple cores, the data including at least one of information and an instruction, the information being at least one of an operand and flow control information, wherein at least one of the downstream one of the plurality of ultra simple cores is connected to receive at least one of an instruction and flow control information streamed from the respective at least one upstream one of the plurality of ultra simple cores.

This could be a processor-readable medium wherein connecting includes connecting directly.

This could be a processor-readable medium wherein connecting includes connecting indirectly via a communication bus.

This could be a processor-readable medium wherein connecting includes providing local memory to the downstream one of the plurality of ultra simple cores to store received streamed data.

This could be a processor-readable medium wherein connecting includes providing a sequencer to the downstream one of the plurality of ultra simple cores to sequence received data.

This could be a processor-readable medium wherein providing a sequencer includes providing a sequencer to sequence received streamed data.

This could be a processor-readable medium wherein providing a sequencer includes providing a passive sequencer.

This could be a processor-readable medium wherein providing a sequencer includes providing an active sequencer.

This could be a processor-readable medium wherein providing an active sequencer includes providing a sequencer memory and an execution memory.

This could be a processor-readable medium wherein providing a sequencer includes connecting the sequencer to receive configuration data.

This could be a processor-readable medium wherein connecting includes providing delay buffers to the downstream one of the plurality of ultra simple cores to delay received streamed data.

This could be a processor-readable medium wherein connecting includes providing an execution unit to the downstream one of the plurality of ultra simple cores to execute received streamed data.

This could be a processor-readable medium wherein connecting includes connecting the execution unit to receive streamed data via the local memory.

This could be a processor-readable medium wherein connecting includes connecting the execution unit to receive streamed data via the local memory via the delay buffers.

This could be a processor-readable medium wherein connecting includes connecting the execution unit to receive streamed data via the local memory via the delay buffers via the local memory.

This could be a processor-readable medium wherein connecting includes connecting the execution unit to receive streamed data via the local memory via the sequencer.

This could be a processor-readable medium wherein connecting includes connecting the execution unit to receive streamed data via the local memory via the sequencer via the delay buffers.

This could be a processor-readable medium wherein connecting includes creating a feedback delay.

This could be a processor-readable medium wherein creating a feedback delay includes configuring the sequencer to direct the execution unit to a series of idle instructions.

This could be a processor-readable medium wherein creating a feedback delay includes configuring the sequencer to direct the execution unit to execute a plurality of instructions for a plurality of clock cycles.

This could be a processor-readable medium wherein configuring includes providing the plurality of ultra simple cores with a plurality of respective memory banks.

This could be a processor-readable medium wherein providing includes connecting one of the plurality of the ultra simple cores directly to its respective one of the plurality of memory banks.

This could be a processor-readable medium wherein providing includes connecting one of the plurality of the ultra simple cores indirectly to its respective one of the plurality of memory banks via a memory bus.

This could be a processor-readable medium wherein providing includes connecting one of the plurality of the ultra simple cores indirectly via another one of the plurality of the ultra simple cores to the respective one of the plurality of memory banks of the another one of the plurality of the ultra simple cores.

This could be a processor-readable medium further comprising connecting the plurality of ultra simple cores to exchange data with a base processor.

This could be a processor-readable medium further including connecting the plurality of ultra simple cores and the base processor to shared storage.

According to another aspect of the invention, there is provided a processor-readable medium encoding sequences of information and instructions which, when executed by a plurality of ultra simple cores causes the plurality of ultra simple cores to operate as a multi-mode instruction-level streaming system, the information and instructions comprising the steps of streaming to each downstream one of the plurality of ultra simple cores data from a respective at least one upstream one of the plurality of ultra simple cores, the data including at least one of information and an instruction, the information being at least one of an operand and flow control information, wherein at least one of the respective at least one upstream one of the plurality of ultra simple cores streams at least one of an instruction and flow control information.

This could be a processor-readable medium wherein streaming includes storing the streamed data at the downstream one of the plurality of ultra simple cores.

This could be a processor-readable medium further including at least one of executing the streamed data and executing upon the streamed data at the downstream one of the plurality of ultra simple cores.

This could be a processor-readable medium wherein storing includes sequencing the streamed data.

This could be a processor-readable medium further including at least one of executing the streamed data and executing upon the streamed data at the downstream one of the plurality of ultra simple cores.

This could be a processor-readable medium wherein storing includes delaying the streamed data.

This could be a processor-readable medium further including at least one of executing the streamed data and executing upon the streamed data at the downstream one of the plurality of ultra simple cores.

This could be a processor-readable medium wherein storing includes delaying the streamed data.

This could be a processor-readable medium further including at least one of executing the streamed data and executing upon the streamed data at the downstream one of the plurality of ultra simple cores.

This could be a processor-readable medium further including at least one of executing the streamed data and executing upon the streamed data at the downstream one of the plurality of ultra simple cores.

This could be a processor-readable medium wherein executing includes branching.

This could be a processor-readable medium wherein branching includes branching without interrupting the stream.

This could be a processor-readable medium wherein branching includes branching in response to an instruction in the streamed data.

This could be a processor-readable medium wherein branching includes branching in response to flow control information in the streamed data.

According to another aspect of the invention, there is provided a carrier wave embodying a data signal representing sequences of information and instructions which, when executed by a processor cause the processor to configure a plurality of ultra simple cores, the information and instructions comprising the steps of connecting each downstream one of the plurality of ultra simple cores to receive data streamed from a respective at least one upstream one of the plurality of ultra simple cores, the data including at least one of information and an instruction, the information being at least one of an operand and flow control information, wherein at least one of the downstream one of the plurality of ultra simple cores is connected to receive at least one of an instruction and flow control information streamed from the respective at least one upstream one of the plurality of ultra simple cores.

This could be a carrier wave wherein connecting includes connecting directly.

This could be a carrier wave wherein connecting includes connecting indirectly via a communication bus.

This could be a carrier wave wherein connecting includes providing local memory to the downstream one of the plurality of ultra simple cores to store received streamed data.

This could be a carrier wave wherein connecting includes providing a sequencer to the downstream one of the plurality of ultra simple cores to sequence received data.

This could be a carrier wave wherein providing a sequencer includes providing a sequencer to sequence received streamed data.

This could be a carrier wave wherein providing a sequencer includes providing a passive sequencer.

This could be a carrier wave wherein providing a sequencer includes providing an active sequencer.

This could be a carrier wave wherein providing an active sequencer includes providing a sequencer memory and an execution memory.

This could be a carrier wave wherein providing a sequencer includes connecting the sequencer to receive configuration data.

This could be a carrier wave wherein connecting includes providing delay buffers to the downstream one of the plurality of ultra simple cores to delay received streamed data.

This could be a carrier wave wherein connecting includes providing an execution unit to the downstream one of the plurality of ultra simple cores to execute received streamed data.

This could be a carrier wave wherein connecting includes connecting the execution unit to receive streamed data via the local memory.

This could be a carrier wave wherein connecting includes connecting the execution unit to receive streamed data via the local memory via the delay buffers.

This could be a carrier wave wherein connecting includes connecting the execution unit to receive streamed data via the local memory via the delay buffers via the local memory.

This could be a carrier wave wherein connecting includes connecting the execution unit to receive streamed data via the local memory via the sequencer.

This could be a carrier wave wherein connecting includes connecting the execution unit to receive streamed data via the local memory via the sequencer via the delay buffers.

This could be a carrier wave wherein connecting includes creating a feedback delay.

This could be a carrier wave wherein creating a feedback delay includes configuring the sequencer to direct the execution unit to a series of idle instructions.

This could be a carrier wave wherein creating a feedback delay includes configuring the sequencer to direct the execution unit to execute a plurality of instructions for a plurality of clock cycles.

This could be a carrier wave wherein configuring includes providing the plurality of ultra simple cores with a plurality of respective memory banks.

This could be a carrier wave wherein providing includes connecting one of the plurality of the ultra simple cores directly to its respective one of the plurality of memory banks.

This could be a carrier wave wherein providing includes connecting one of the plurality of the ultra simple cores indirectly to its respective one of the plurality of memory banks via a memory bus.

This could be a carrier wave wherein providing includes connecting one of the plurality of the ultra simple cores indirectly via another one of the plurality of the ultra simple cores to the respective one of the plurality of memory banks of the another one of the plurality of the ultra simple cores.

This could be a carrier wave further comprising connecting the plurality of ultra simple cores to exchange data with a base processor.

This could be a carrier wave further including connecting the plurality of ultra simple cores and the base processor to shared storage.

According to another aspect of the invention, there is provided a carrier wave embodying a data signal representing sequences of information and instructions which, when executed by a plurality of ultra simple cores causes the plurality of ultra simple cores to operate as a multi-mode instruction-level streaming system, the information and instructions comprising the steps of streaming to each downstream one of the plurality of ultra simple cores data from a respective at least one upstream one of the plurality of ultra simple cores, the data including at least one of information and an instruction, the information being at least one of an operand and flow control information, wherein at least one of the respective at least one upstream one of the plurality of ultra simple cores streams at least one of an instruction and flow control information.

This could be a carrier wave wherein streaming includes storing the streamed data at the downstream one of the plurality of ultra simple cores.

This could be a carrier wave further including at least one of executing the streamed data and executing upon the streamed data at the downstream one of the plurality of ultra simple cores.

This could be a carrier wave wherein storing includes sequencing the streamed data.

This could be a carrier wave further including at least one of executing the streamed data and executing upon the streamed data at the downstream one of the plurality of ultra simple cores.

This could be a carrier wave wherein storing includes delaying the streamed data.

This could be a carrier wave further including at least one of executing the streamed data and executing upon the streamed data at the downstream one of the plurality of ultra simple cores.

This could be a carrier wave wherein storing includes delaying the streamed data.

This could be a carrier wave further including at least one of executing the streamed data and executing upon the streamed data at the downstream one of the plurality of ultra simple cores.

This could be a carrier wave further including at least one of executing the streamed data and executing upon the streamed data at the downstream one of the plurality of ultra simple cores.

This could be a carrier wave wherein executing includes branching.

This could be a carrier wave wherein branching includes branching without interrupting the stream.

This could be a carrier wave wherein branching includes branching in response to an instruction in the streamed data.

This could be a carrier wave wherein branching includes branching in response to flow control information in the streamed data.

According to yet another aspect of the present invention, there is provided a system having a plurality of ultra simple cores, comprising a respective pathway connecting each downstream one of the plurality of ultra simple cores to receive data streamed from a respective at least one upstream one of the plurality of ultra simple cores, the data including at least one of information and an instruction, the information being at least one of an operand and flow control information, wherein at least one of the downstream one of the plurality of ultra simple cores is connected to receive at least one of an instruction and flow control information streamed from the respective at least one upstream one of the plurality of ultra simple cores.

This could be a system wherein each respective pathway is one of connecting a direct connection and a bus connection.

This could be a system wherein at least one downstream one of the plurality of ultra simple cores has a local memory to store received streamed data.

This could be a system wherein the at least one downstream one of the plurality of ultra simple cores has a sequencer to the downstream one of the plurality of ultra simple cores to sequence received data.

This could be a system wherein the at least one downstream one of the plurality of ultra simple cores has a sequencer to the downstream one of the plurality of ultra simple cores to sequence received streamed data.

This could be a system wherein the sequencer is a passive sequencer.

This could be a system wherein the sequencer is an active sequencer.

This could be a system wherein the active sequencer has a sequencer memory and an execution memory.

This could be a system wherein the sequencer is connected to receive configuration data.

This could be a system wherein the at least one downstream one of the plurality of ultra simple cores has delay buffers to delay received streamed data.

This could be a system wherein the at least one downstream one of the plurality of ultra simple cores has an execution to execute received streamed data.

This could be a system wherein the execution unit is connected to receive streamed data via the local memory.

This could be a system wherein the execution unit is connected to receive streamed data via the local memory via the delay buffers.

This could be a system wherein the execution unit is connected to receive streamed data via the local memory via the delay buffers via the local memory.

This could be a system wherein the execution unit is connected to receive streamed data via the local memory via the sequencer.

This could be a system wherein the execution unit is connected to receive streamed data via the local memory via the sequencer via the delay buffers.

This could be a system wherein the sequencer is configured to direct the execution unit to a series of idle instructions to produce a feedback delay.

This could be a system wherein the sequencer is configured the sequencer to direct the execution unit to execute a plurality of instructions for a plurality of clock cycles.

This could be a system wherein the plurality of ultra simple cores are connected to a plurality of respective memory banks.

This could be a system wherein at least one of the plurality of the ultra simple cores is connected directly to its respective one of the plurality of memory banks.

This could be a system wherein at least one of the plurality of the ultra simple cores is connected indirectly to its respective one of the plurality of memory banks via a memory bus.

This could be a system wherein at least one of the plurality of the ultra simple cores is connected indirectly via another one of the plurality of the ultra simple cores to the respective one of the plurality of memory banks of the another one of the plurality of the ultra simple cores.

This could be a system further comprising a base processor connected to exchange data with the plurality of ultra simple cores.

This could be a system further including shared storage connected to the plurality of ultra simple cores and the base processor.

Further aspects and advantages of the present invention will become apparent upon considering the following drawings, description, and claims.

### BRIEF DESCRIPTION OF THE DRAWINGS

The invention will be more fully illustrated by the following detailed description of non-limiting specific embodiments in conjunction with the accompanying drawing figures. In the figures, similar elements and/or features may have the same reference label. Further, various elements of the same type may be distinguished by following the reference label with a second label that distinguishes among the similar elements. If only the first reference label is identified in a particular passage of the detailed description, then that passage describes any one of the similar elements having the same first reference label irrespective of the second reference label.

FIG. 1 Logical organization of a USC according to one embodiment of the invention.

FIG. 2 Logical organization of a USC according to another embodiment of the invention.

FIG. 3 A & B: Logical organization of a sequencer memory logical module according to one embodiment of the invention.

FIG. 4 Logical organization of memory access architecture according to several embodiments of the invention.

FIG. 5 Logical organization of the MM-ILS system according to one embodiment of the invention.

FIG. 6 Flowchart for operation of one embodiment of synchronous mode of MM-ILS.

### DETAILED DESCRIPTION OF THE INVENTION

### Terminology

Acronyms

| | |
|---|---|
| API | application programming interface |
| ASIC | application-specific integrated circuit |
| CPU | central processing unit |
| DMA | direct memory access |
| DSP | digital signal processing |
| FFT | fast fourier transform |
| FPGA | field-programmable gate array |
| GPP | general purpose processor |
| GPU | graphics processing unit |
| I/O | input/output |
| ILS | instruction-level streaming |
| MC | memory controller |
| MM-ILS | multi-mode instruction-level streaming |
| NOP | no operation/no operation performed |
| SM-ILS | single-mode instruction-level streaming |
| USC | ultra simple core |
| VLIW | very long instruction word |

Terms

| | |
|---|---|
| data | includes both instructions that will be stored in a program |
| | memory or processed by a sequencer, and information on |
| | which an instruction will be performed by an execution unit |
| downstream | a USC is downstream of a neighbouring USC if it receives |
| | data streamed from the neighbouring USC; USCs can be |
| | both upstream and downstream of each other, for example, |
| | in the case of feedback loops. |
| flow control | includes both explicit flow control—where flow control |
| | instructions are streamed from an upstream USC to a |
| | downstream USC, and implicit flow control—where flow |
| | control information is streamed from an upstream USC to |
| | downstream USC |
| information | includes both information samples and flow control |
| | information |
| I/O | used in a generic sense to refer to any input/output system or |
| | arrangement or way of getting data in or out of an MM-ILS |
| | system |
| neighbouring | neighbouring means merely that a pathway, direct or indirect, |
| | has been configured between two USCs and does not |
| | necessarily mean the two USCs are physically proximate |
| sequencer | a sequencer directs an execution unit to the next instruction to |
| | be executed |
| streaming | streaming is a process where data is taken from one execution |
| | entity to another for processing in a continuous manner, |
| | without data movement, scheduling or other control |
| | instructions |
| upstream | a USC is upstream of a neighbouring USC if it streams data |
| | to the neighbouring USC; USCs can be both upstream and |
| | downstream of each other, for example in the case of |
| | feedback loops |
| ultra simple | is a programmable execution unit with an instruction set, and |
| core | can be embodied in physical or virtual form |

Foundational Technology This patent application is related to co-pending U.S. patent application Ser. No. 12/729,131, filed Mar. 3, 2010, entitled “Reconfigurable Computing System and Method of Developing Application for Deployment on the Same”, the contents of which are incorporated by reference in its entirety and assigned to the assignee of the present invention.

### Exemplary Embodiments

### Contrast to Single-Instruction USCs

In SM-ILS technology, when the system is configured (at the mapping stage), each USC is configured to execute one particular instruction for the duration of the application. Data is then streamed between the USCs, with each USC performing a pre-configured instruction on the data and passing the data onto the next USC or to an I/O. However, some applications benefit from an ILS architecture in which USCs can execute more than one instruction during the course of the execution of the application. For example, multi-rate applications can achieve higher hardware utilizations if USCs can execute several different simpler instructions at a high rate, rather than one complex instruction at a lower rate. Another example is applications with feedback loops. Loops require the execution rate on USCs to be slowed to allow computed results to propagate up a graph. Allowing a USC to execute multiple instructions can lead to more efficient hardware utilization. To obtain the benefit of ILS technology, the selection of instructions to be executed, and the execution of the instructions, must take place without the use of data movement or scheduling instructions.

To allow USCs to execute different instructions, the ILS system must include one or more sequencers that allow a USC to select an instruction to be executed. To select instructions without slowing down data flow, the sequencers may include their own execution units used to perform operations necessary to generate or select an instruction.

The system of USCs remains close-knit such that the USCs have access to neighboring USC's internal memories or register files, and the sequencers form part of the ILS system rather than being an external controller that issues data movement or scheduling instructions. In this sense, neighbouring doesn't necessarily mean physical proximity, but merely that a pathway has been configured between two USCs.

Depending on the implementation, a sequencer may be included in each USC or may be a separate module in the ILS system that provides sequencer functionality to one or more USCs. This multi-instruction ILS technology which includes sequencers is referred to as multi-mode ILS (MM-ILS) and is described below.

### Multi-Instruction USCs

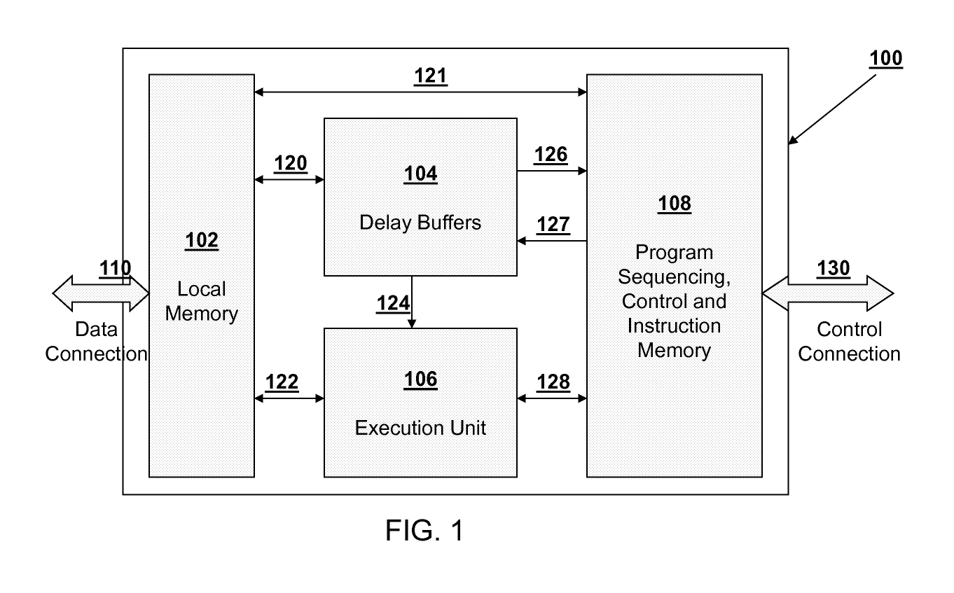

Referring to FIG. 1, one embodiment of a USC in a MM-ILS architecture, shown generally at 100, is illustrated with reference to its functional components. A person skilled in the art will appreciate that the USC 100 may be implemented in a variety of hardware architectures, including FPGAs and ASICs. Furthermore, a person skilled in the art will appreciate that the functional components of the USC 100 do not have to reside on a single chip, but may be distributed between or implemented by different chips on one or more boards or distributed between discrete devices loosely coupled with dynamic links. For example, for board-level implementation, each functional component may be implemented as a separate, generic or custom designed chip, and all such chips interconnected by a high speed bus. In this implementation, any combination of ASICs, FPGAs, GPUs, and other chips may be used. The latency, processing power, cost constraints, and other parameters of a particular application being implemented via the MM-ILS technology will dictate the physical implementation and configuration of the USC 100. A person skilled in the art will appreciate that constraints and parameters will change over time as technology develops and improves, and implementations and applications of the MM-ILS technology will be enabled that are not possible at the present time. For example, advancements in quantum computing and instantaneous communications enabled thereby, may enable functional components of a USC to be distributed to different locations without compromising performance or efficiency.

The USC 100 has two bidirectional connections to the “outside world”: a data connection 110 and a control connection 130.

The data connection 110 connects the USC 100 to other devices within the MM-ILS system, such as neighboring USCs (not shown), I/O devices or interfaces (not shown), or memories (not shown). Throughout this description, the term “I/O” is used in a generic sense to refer to any input/output system or arrangement or way of getting data in or out of the MM-ILS system.

The data connection 110 is used to provide data to be processed to the USC 100 and output data that has been processed by the USC 100. The term data as used in this description includes information on which an instruction will be performed by an execution unit 106 and instructions that will be stored in a program memory 108.

The control connection 130 connects the USC 100 to control and configuration devices which do not form part of the active MM-ILS system; such devices include a global controller (not shown), a clock management system (not shown), or other USCs (not shown).

The control connection 130 is used to provide control instructions and data to the USC 100, such as configuration instructions prior to execution and execution control instructions, for example, debugging and step-by-step execution instructions.

Both data connections 110 and control connections 130 may be direct connections (point to point links) or indirect connections (via physical buses or networks).

USCs in an MM-ILS system require no data movement or scheduling instructions and may be clock-synchronized or be used in asynchronous mode with handshaking between upstream and downstream USCs. For example, an upstream USC may signal a downstream USC when data should be read, or a downstream USC may signal when data should be sent. When clock synchronization is used, the particular method of clock synchronization will depend on the implementation of the particular MM-ILS system. For example, for board-level implementations, each USC 100 may have a clock input (not shown) from a central clock (not shown), and for network-level implementations, clock synchronization may be achieved through clock-sync signals arriving over the data connection 110 from other USCs in the MM-ILS network or over the control connection 130 from other devices.

The MM-ILS architecture and attendant tools (for example a suitable compiler) provide a way for configuring a plurality of USCs 100, connecting each downstream one of the plurality of USCs 100 to receive data streamed from a respective at least one upstream one of the plurality of USCs 100, the data including at least one of information and an instruction to be executed, the information being at least one of an operand (for example an information sample to be processed) and flow control information (for example, an evaluation at an upstream USC 100 of a branching condition), wherein at least one of the downstream one of the plurality of USCs 100 is connected to receive at least one of an instruction and flow control information streamed from the respective at least one upstream one of the plurality of USCs 100.

### Local Memory

Data arriving at the USC 100 across the data connection 110 arrives directly at a local memory 102. Similarly, data leaving the USC 100 over the data connection 110 passes through the local memory 102. The local memory 102 is functionally similar to an on-chip cache or registers within a CPU. It is, in essence, a fast memory dedicated to the USC 100. A person skilled in the art will appreciate that the local memory 102 may be configured as a single logical storage space or may be divided into registers or locations of specific bit-widths. For example, a 40-bit local memory 102 may contain four 1-bit Boolean flags and two 18-bit integers. The type and configuration of the local memory 102 depends on the application for which the MM-ILS system is being used.

The use of the local memory 102 coupled directly to the data connection 110 facilitates close integration between USCs in an MM-ILS system such that one USC is able to directly access the internal memory (the local memory 102) of a neighbouring USC without the use of data movement or scheduling instructions.

From the local memory 102, information to be processed can be sent to the execution unit 106 in various ways, for example, (i) directly, via an internal link 122, (ii) through delay buffers 104, via internal links 120, 124, or (iii) through the delay buffers 104 via the internal link 120, back to the local memory 102 via the internal link 120, and then to the execution unit 106 via the internal link 122.

Similarly, from the local memory 102, instructions (in the form of programmatic operands) can be sent to the program memory 108 in various ways, for example, (i) directly, via an internal link 121, (ii) through the delay buffers 104, via internal links 120, 126, or (iii) through the delay buffers 104 via the internal link 120, back to the local memory 102 via the internal link 120, and then to the program memory 108 via the internal link 121.

### Delay Buffers

Delay buffers 104 are a functional component well known in the art and may be used to align data arriving into the USC 100 before it reaches the execution unit 106 or the program memory 108. Specifically, the delay buffers 104 equalize the path delays by selectively introducing specific further delays into the data stream.

Misalignment of data may be caused by different path delays when streaming data to the USC 100 from different sources (not shown). For example, a programmer writing sequential code requires a simple addition of operands A and B to achieve a result C. Sequential code presupposes that by the time the addition is to be done, both A and B are available. However, in parallel systems, A and B may be results of other operations by other USCs and may arrive at the USC 100 at different times. The function of the delay buffers 104 is to delay passing information onto the execution unit 106 for addition until both A and B have arrived.

The operation of the delay buffers 104 may be controlled by instructions stored in the program memory 108, which instructions are received via an internal link 127, as described in more detail below.

A person skilled in the art will appreciate that the particular manner of interconnecting the local memory 102, the execution unit 106, and the program memory 108, directly or through the delay buffers 104, will depend on the application for which the MM-ILS system is intended, the nature of the data being processed, and the functions or limitations of the USCs used and the pathways between them. For example, in some configurations, internal links 121 and 122 may be omitted such that data must always pass through the delay buffers 104. In other configurations, the delay buffers 104 may be connected directly to the data connection 110 and thus be placed as a buffer to the local memory 102.

### Execution Unit

Unlike the SM-ILS technology, where each USC is configured to execute a single instruction, the USCs in MM-ILS systems may (but do not have to) execute different instructions. In the USC 100, the actual execution of an instruction, which is obtained from the program memory 108 via an internal link 128, is performed by the execution unit 106. The instruction may perform an operation on information obtained from the local memory 102 (directly via the internal link 122 or through the delay buffers 104) or may perform an internal function, such as ascertaining the location of the next instruction to be obtained from the program memory 108, or generating a control instruction for the delay buffers 104. Similarly, depending on the instruction, the result may be output to the local memory 102 via the internal link 122 or to the program memory 108 via the internal link 128.

Generally, instructions obtained by the execution unit 106 from the program memory 108 contain the following parameters: (i) where to obtain data on which the instruction will be performed (the local memory 102 or the program memory 108); (ii) which operation to perform; (iii) when to perform it; and (iv) where to store the result (the local memory 102 or the program memory 108). Operations may be arithmetic, logical, bit manipulation, compound operation such as add-compare-select as known in prior art, or control operations, such as branch calculation, to facilitate conditional execution of other instructions.

A person skilled in the art will appreciate that a USC may include a plurality of execution units for internally parallel execution. For example, a USC may contain two 16-bit adders, which will, in parallel, add 16-bit integers obtained from the local cache 102 to general a 32-bit integer result. As with the overall MM-ILS system, such parallelism is “hidden” from the programmer who writes sequential code. The compiler extracting application graphs and mapping them onto the MM-ILS system is aware of system parameters and will optimize utilization.

MM-ILS employs continuous streaming of all data, including instructions, and does not rely on externally managed flow control. The instructions to be executed by each USC are either explicitly received from an upstream USC or are determined based on other information received from the upstream USC. To enable such operation in a streaming fashion, each USC used in an MM-ILS system includes or has access to an active or passive sequencer, which ensures that the USC and the execution unit therein is not stalled even by complex flow control.

### Program Memory (as a Passive Sequencer)

In one embodiment, a passive sequencer is used, implemented as the program memory 108. The program memory 108 is a memory bank which contains instructions that configure or operate the execution unit 106 and the delay buffers 104. For example, a specific memory space in the program memory 108 may be dedicated to instructions for the delay buffers 104 and another memory space may be dedicated to instructions for the execution unit 106. Instructions in the program memory 108 are populated in one of the following ways: (i) loaded at the time when the MM-ILS system is configured via the control connection 130; (ii) received externally (e.g. from other USCs) via the data connection 110 (directly or through the delay buffers 104); and (iii) received from the execution unit 106 as a result of execution of an instruction (directly or through the delay buffers 104). In certain configurations, instructions may also be received at run-time via the control connection 130. Thus, the sequencer sequences received data, in many embodiments received streamed data.

The delay buffers 104 access a dedicated memory space in the program memory 108, via the internal link 127, which memory space contains instructions to configure the delay buffers 104. For example, instructions may contain information about the registers in the local memory 102 which contain information that must be delayed and by how much to delay it. Depending on the implementation, the delay buffers 104 may access the instructions in the program memory 108 at the beginning of the execution of the application, at each clock cycle, as directed by the execution unit 106, or as directed via the control connection 130.

The execution unit 106 accesses the program memory 108 via the internal link 128 to obtain instructions to be executed and, when necessary, to output instructions into the execution memory 108, which instructions will be used by the execution unit 106 or by the delay buffers 104. In this embodiment, the execution unit 106 executes both information manipulation and flow control instructions streamed to it.

It is important to note that flow control instructions are not issued by a centralized controller, as in pipelined systems known in the art; rather, they are included in the streaming data and their execution is modeled at the time the system is mapped.

Furthermore, such flow control can be implemented either explicitly by streaming actual flow control instructions, or implicitly by streaming mere flow control information. For example, consider an upstream USC 100 configured to determine if a variable A has a value less than 0 (“true”) or not less than 0 (“false”) and a downstream USC 100 configured to set a variable B to a value x when the variable A has a value less than 0 (“Instruction1”) and to set the variable B to a value y when the variable A has a value not less than 0 (“Instruction2”).

In an explicit implementation of flow control, the upstream USC 100 would test if the value of variable A was less than 0: if true, the upstream USC 100 would stream to the downstream USC 100 instruction Instruction1 and if false, the upstream USC 100 would stream to the downstream USC 100 instruction Instruction2.

In an implicit implementation of flow control, the upstream USC 100 would test if the value of variable A was less than 0 and merely stream to the downstream USC 100 either the information true or the information false. Based on the streamed information received, the downstream USC 100 would select between executing instruction Instruction1 and instruction Instruction2.

It is important to note that all instructions stored in the program memory 108 or performed by the execution unit 106 have significance only to the operation of the USC 100 within which these modules are located. There are no instructions to explicitly move data between USCs, or between the local memory 102 and external memories or I/Os.

Thus, it will be seen that this arrangement provides a method of operating a plurality of ultra simple cores, comprising streaming to each downstream one of the plurality of ultra simple cores data from a respective at least one upstream one of the plurality of ultra simple cores, the data including at least one of information and an instruction, the information being at least one of an operand and flow control information, wherein at least one of the respective at least one upstream one of the plurality of ultra simple cores streams at least one of an instruction and flow control information.

### Active Sequencer

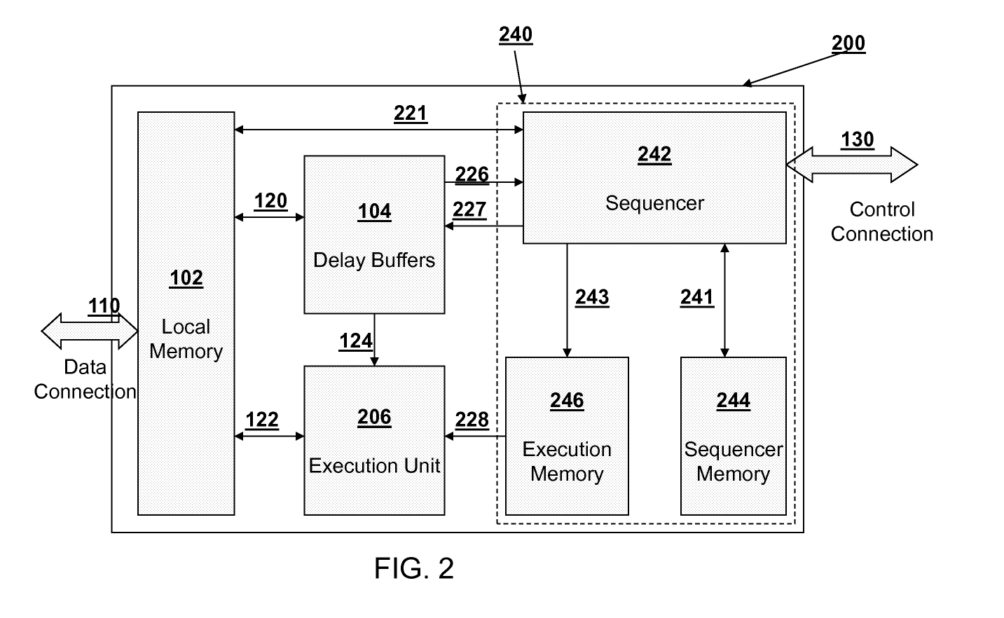

Referring to FIG. 2, a second embodiment of a USC used in the MM-ILS system is shown generally at 200, wherein the program memory 108 of the USC 100 is replaced with a sequencer module 240. Unlike the program memory 108, the sequencer module 240 is an active component that includes a sequencer 242, which performs all control operations, such as branch calculations and generation of instructions for the delay buffers 104 and/or an execution unit 206. In the second embodiment USC 200, unlike the first embodiment USC 100, control instructions are not executed by the execution unit 206, thus leaving more capacity for execution of information processing instructions.

The sequencer module 240 also comprises a sequencer memory 244 and an execution memory 246, and internal links 241, 243. To integrate the sequencer module 240 into the USC 200, the sequencer 242 is connected to the delay buffers 104 and/or the local memory 102 via internal links 221, 226, 227, and the execution memory 246 is connected to the execution unit 206 via an internal link 228. The sequencer module 240 is connected to the “outside world” via the local memory 102 and the data connection 110, as described above, or via the control connection 130.

The execution memory 246 contains instructions for the execution unit 106. The function of the sequencer 242 is to generate an address for the execution memory 246 such that, in each cycle, the execution unit 206 will obtain from that address, via the internal link 228, an instruction to perform. The sequencer memory 244 contains addresses for the execution memory 246, and information for the sequencer 242 on how to generate these addresses.

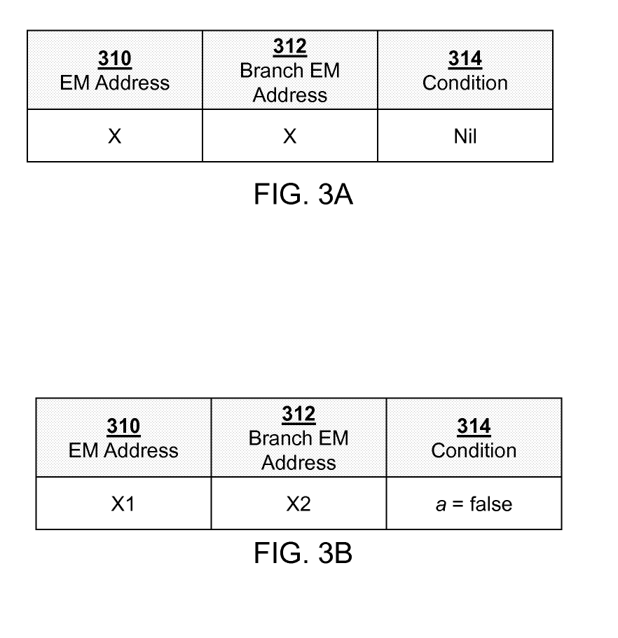

To facilitate understanding of the operation of the sequencer module 240, two examples are set out below with references to FIGS. 3A and 3B. In these examples, the sequencer memory 244 is divided into memory “cells”, each one of which has three parts: (i) an address 310 of a location in the execution memory 246; (ii) an address 312 of a branch location in the execution memory 246; and (iii) a condition 314 for when the branch can be taken.

With reference to FIG. 3A, a situation is illustrated where a particular USC 200 is intended to execute only a single instruction for the duration of the application. In this situation, the address of that instruction (X) in the execution memory 246 is placed in locations 310 and 312, and condition 314 not used. At each clock cycle, the sequencer 342 will therefore generate the same address X, from which the execution unit 206 will obtain the instruction from the execution memory 246. In this configuration, during run-time, the sequencer 242 does not need to receive any data from other USCs 200 via the data connection 110.

With reference to FIG. 3B, in other configurations, a particular USC 200 is intended to execute one of two instructions, chosen based on data received from one or more neighboring USCs 200 via the data connection 110. In this example, the particular USC 200 is intended to execute the following simple conditional algorithm:

if (a){b=c;}

else {b=d;}

In this scenario, the value a arrives from a neighboring USC 200 (or perhaps from an I/O) via the data connection 110 and is stored in the local memory 102. The sequencer memory 244 contains address X1 at location 310, address X2 at branch location 312, and condition a=false at location 314. Address X1 in the execution memory 246 contains an instruction corresponding to b=c, and address X2 in the execution memory 246 contains an instruction corresponding to b=d. The sequencer 242 will evaluate the condition at location 314 and select X1 or X2. The address X1 or X2 will then be passed onto the execution unit 206, which will obtain from that address the necessary instruction.

In another embodiment, the locations 310 and 312 may contain addresses of other cells in the sequencer memory 244, which cells will contain addresses of instructions in the execution memory 246 or further conditions to be evaluated.

One can observe in this example that, if the value a is streamed into the USC 200 at a rate equal to the USC's clock frequency, then the USC 200 is able to perform a conditional execution and stream the result b out at the same rate. If there is only a single instruction memory and the same resources are used for evaluating conditions and executing, the USC 200 will not be able to maintain the same rate because the processor will have to alternate between evaluating the condition and performing the execution. In prior art, where branch prediction is used (as opposed to ILS), the performance will be even lower when the branch is mispredicted.

In other embodiments, the sequencer 242 may communicate directly with sequencers in other USCs 200, via either the data connection 110 or the control connection 130, to orchestrate branching and conditional executions across the entire MM-ILS system.

Other separation techniques are also possible. For example by concatenating the execution memory 246 and the sequencer memory 244 together to form a Very Long Instruction Word (VLIW) or similar, the same instruction can contain both sequencing and execution data.

A person skilled in the art will appreciate that there are many ways to configure the sequencer module 240 to achieve the branch evaluation and control functionality necessary for MM-ILS. Thus, different combinations of components, interconnections, memory structures, and calculation methods may be employed within the sequencer module 240 and the above description constitutes merely one embodiment of the same.

Thus, it will be seen that this arrangement provides a method of operating a plurality of ultra simple cores, comprising streaming to each downstream one of the plurality of ultra simple cores data from a respective at least one upstream one of the plurality of ultra simple cores, the data including at least one of information and an instruction, the information being at least one of an operand and flow control information, wherein at least one of the respective at least one upstream one of the plurality of ultra simple cores streams at least one of an instruction and flow control information.

### Memory Architecture

The ILS technology allows implementation of a distributed memory architecture which efficiently handles block-based parallel processing. Block-based processing requires data to be collected before processing can begin. For instance, Fast Fourier Transform (FFT) processing often cannot start until a block of data is available. In some cases, data may be collected elsewhere and then passed along for further processing. In all cases, multiple simultaneous memory accesses significantly improve processing performance by allowing each processor to access its own data block. Unfortunately, memories typically support only up to two simultaneous read/write accesses.

Distributing a large memory space into smaller physical memory banks solves the above problem. With ILS, a USC 200 can access one memory bank, process the data, and store the result in yet another memory bank.

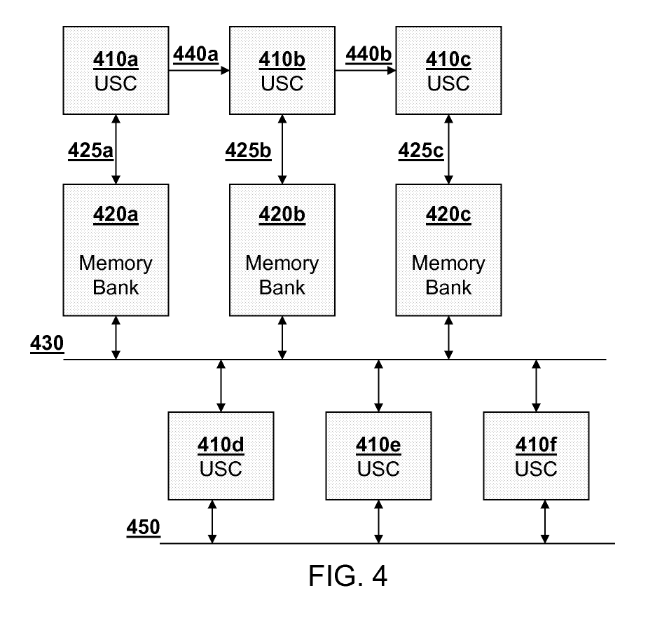

As shown in FIG. 4, such access may be performed by USCs 410 either through direct connections to memory banks 420 via connections 425, or a through a high speed memory bus 430. The same USCs 410 may stream data to each other via direct connections 440, via the same bus 430, or via a separate communications bus 450.

Where the same memory banks 420 need to be accessed also by a sequential part of an application which is being executed by a base processor (not shown) of a CPU (not shown), a problem of keeping track of data accesses may be introduced. In particular, while the USCs 410, each one of which is executing a specific instruction, treat each memory bank discretely 420, a contiguous address space needs to be presented to the base processor (not shown).

Manual management of memory access, as is the case with Graphics Processing Unit (GPU) technologies, is tedious. Instead, using a memory controller (MC) described below, ILS technology can transparently manage accesses such that sequential parts of a running application, usually executed by a regular CPU, will still maintain the notion of a single contiguous memory. Therefore, application development remains sequential with no explicit memory access management.

In this regard, the MC might be programmed or configured to perform memory control functions independently of the USCs 410 or be, in effect, a USC dedicated to memory management, for example USC 410f. More specifically, to implement transparent memory access management, the MC can be programmed or configured to perform at least some of the following functions:

(1) Access data from system memory, preferably using direct memory access (DMA), split the data into different physical memory banks 420 for processing, collect the result into one or more memory banks 420, and store the result, preferably via DMA, back in the system memory.

(2) Get memory access requests from USCs 410 and explicitly direct them to corresponding memory banks 420.

(3) Transparently (re)direct memory access requests. For instance, some applications may be improved by alternating accesses to different memory banks 420: in a particular iteration, a set of USCs 410 may read from a first memory bank 420a and store the result in a second memory bank 420b. Since the latest or intermediate result is now in the second memory bank 420b, the next iteration can read from the second memory bank 420b, process the data, and store the result in the first memory bank 420a or another memory bank 420c. The MC keeps track of these accesses.

(4) Manage memory data redundancy and parallel access. Some applications can take a further advantage of multiple memory banks 420 by storing the same data set in different memory banks 420a, 420b, 420c to allow more concurrent accesses than would otherwise be possible due to the limited number of access ports per physical memory. The MC can facilitate this mechanism while still presenting to the programmer a single address space.

### System Organization and Programming

The USCs 100, 200, 410 in the MM-ILS architecture are interconnected in any manner appropriate for the application and consistent with available hardware capabilities. For example, the USCs 100, 200, 410 may be interconnected as a mesh, a linear array, a grid, or irregular structures, and via point-to-point, bus, or packet-network interconnections. The main criterion is the ability of the USCs 100, 200, 410 to communicate with each other in the manner described above.

The plurality of USCs 100, 200, 410 may be connected to one or more base processors, which will act as the system controller and provide the primary interface to the programmer. The base processor may have a conventional architecture as known in the art, including a multi-core CPU. It is important however to once again emphasize that instructions and information can be processed by USCs 100, 200, 410 and streamed between them via pathways without the need of data movement, scheduling or other control instructions from a base processor or system controller.

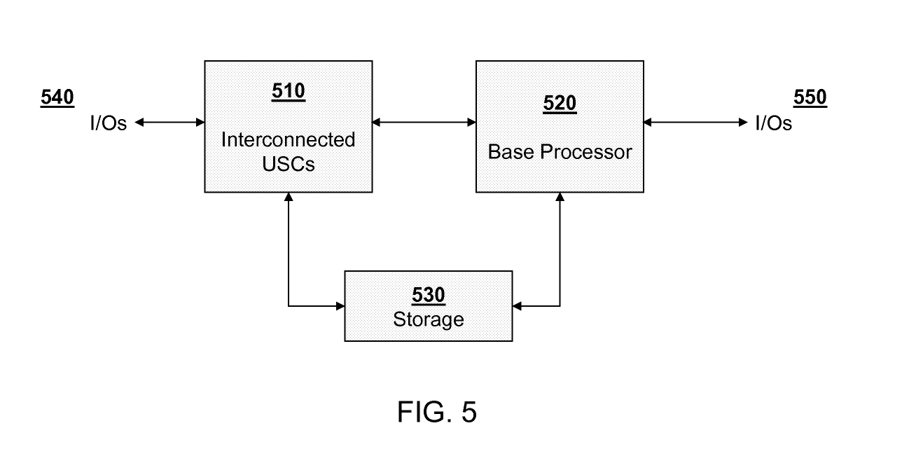

With a reference to FIG. 5, one configuration of an MM-ILS system with a base processor is shown. An interconnected system of USCs 510 is connected to a base processor 520 for control and configuration purposes and is further connected to I/Os 540 and a storage 530. The base processor 520 is connected to the same storage 530 and to I/Os 550 (which may be the same as I/Os 540).

In operation, the system of USCs 510 will perform functions, including accessing the storage 530 and I/Os 540 without intervention from the base processor 520. The I/Os 540 may also provide interconnection to other networks of USCs (not shown) for scalable performance. MM-ILS systems are programmed without the need for gate-level or logic synthesis. As with SM-ILS, programming an MM-ILS system is transparent to the programmer who writes ordinary sequential code. The MM-ILS compiler, aware of the particular MM-ILS architecture on which the code is to be implemented, extracts application graphs from the code and maps them onto the system of USCs 510 described above. The sequential part of the code can be mapped onto the base processor 520. In other embodiments, all instructions of an application may execute on the network of USCs 510 to avoid limitations due to accelerating portions of an application.

The entire MM-ILS system will operate in a streaming fashion with the data rate of the multi-instruction USCs described above being slower than their clock rate, but without affecting the throughput of the system.

### Operation of an MM-ILS System

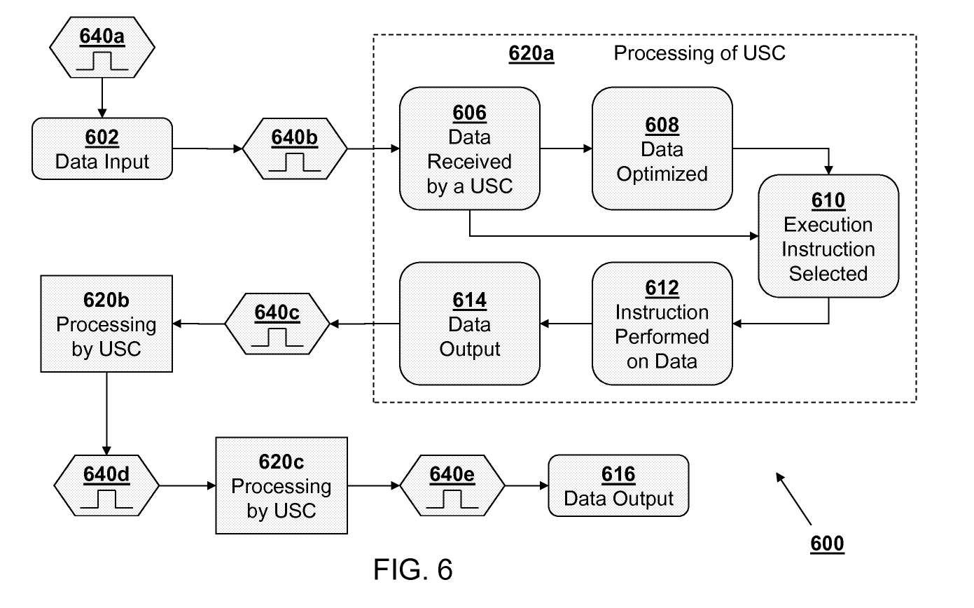

With reference to FIG. 6, one mode of operation of the MM-ILS—synchronous operation—is conceptually illustrated as a flowchart shown generally at 600. For the purpose of the flowchart 600, it is assumed that the sequential code has been compiled and that each USC and the paths between them have already been configured for a particular application, for example, DSP.

Each step in the flowchart—data input 602, operation of USC 620, and data output 616—is performed on each clock cycle 604. With specific reference to the flowchart 600, this means that, during each clock cycle 640, data is input 602, each USC 100, 200, 410 performs its assigned operation 620, and data is output 616. In other words, although the clock cycles are shown sequentially, each one in fact occurs at the same time, and all of the operations shown occur at the same time. Other modes of operation of MM-ILS are also possible, such as asynchronous mode described above.

The system starts with a data input 602, whereby a first information sample A (not shown), of any magnitude, format, or size, is input to the network of USCs 510 during a first clock cycle 640a. In the same step, other types of data may be input, such as control data or instructions for the USCs 100, 200, 410. At a second clock cycle 640b, the first sample A is passed onto a first USC 100, 200, 410 for processing (620a). During the second clock cycle 640b, the USC 100, 200, 410 receives the first sample A (606), optionally, optimizes the received first sample A (608) via delay buffers 104, selects instruction to be executed (610), executes the instruction on the first sample A (612) and outputs the result (614), which we will call once-processed first sample A′ (not shown).

Concurrently, during the same second clock cycle 640b, the data input step 602 was again performed to obtain a second information sample B (not shown).

At a third clock cycle 640c, the once-processed first sample A′ is passed to and processed by the next USC 100, 200, 410 (620b), in the same manner as described above, to generate a twice-processed first sample A″ (not shown). Concurrently, the second information sample B was processed by the first USC 100, 200, 410 (620a) to a once-processed second sample B′ (not shown).

The steps are repeated, with each USC processing the result of the previous operation and the final result being output at step 616. Of particular importance is that the only synchronization required by the system is the common clock. The data is passed between the USCs 100, 200, 410 without any data movement, scheduling or other control instructions from a base processor or system controller.

Thus, it will be seen that this arrangement provides a method of operating a plurality of ultra simple cores, comprising streaming to each downstream one of the plurality of ultra simple cores data from a respective at least one upstream one of the plurality of ultra simple cores, the data including at least one of information and an instruction, the information being at least one of an operand and flow control information, wherein at least one of the respective at least one upstream one of the plurality of ultra simple cores streams at least one of an instruction and flow control information.

Feedback Delay Balancing through Rate Control

Feedback loops in applications cannot be handled by delay balancing through delay buffers 104 described above because data alignment must be conducted at the feedback point.

In the prior art, this problem is handled by modeling feedback path so the clock can be set to observe setup and hold times or by using direct and implicit scheduling of instructions, in which case alignment is guaranteed because of sequential execution.

In MM-ILS, data between USCs 100, 200, 410 is streamed freely once execution commences, without data movement, scheduling or other control instructions from a base processor or system controller. To enable feedback loops, the MM-ILS system adjusts data rates of the incoming paths. The rate of the instructions leading up to the feedback path is slowed by an amount equivalent to delay length through the feedback path.

With reference to FIG. 2, this can be implemented, for example, by the sequencer 240 directing the execution unit 206 to a series of NOP (idle) instructions. In other embodiments, the rate can be controlled by a dedicated clock control circuit (not shown) through the control connection 130.

In other embodiments, rather than slowing the execution units 106, 206 in USCs 100, 200, 410 along the incoming path, the execution units 106, 206 can be configured to execute several instructions in a row, taking several clock cycles. Because of sequential execution, the rate is effectively reduced while retaining streaming.

### Description Summary

Thus, it will be seen from the foregoing embodiments and examples that there has been described a way to implement an ILS system where each USC 100, 200, 410 may execute more than one instruction without compromising performance or functionality, or complicating programming of the system. A number of exemplary ways to configure and operate such systems have been described, and the methodologies of these ways can be implemented in a wide variety of manners, for example in a local or distributed fashion, and with the methodologies being embodied in hardware, encoded in processor-readable media or embodied on a carrier wave.

While specific embodiments of the invention have been described and illustrated, such embodiments should be considered illustrative of the invention only and not as limiting the invention as construed in accordance with the accompanying claims.

It will be understood by those skilled in the art that various changes, modifications and substitutions can be made to the foregoing embodiments without departing from the principle and scope of the invention expressed in the claims made herein.

I claim:

1. A method of configuring a plurality of ultra simple cores, comprising:
connecting each downstream one of the plurality of ultra simple cores to receive data streamed from a respective at least one upstream one of the plurality of ultra simple cores, the data including at least one of information and an instruction, the information being at least one of an operand and flow control information,
wherein at least one of the downstream one of the plurality of ultra simple cores is connected to receive at least one of an instruction and flow control information streamed from the respective at least one upstream one of the plurality of ultra simple cores.

2. A method as claimed in claim 1, wherein connecting includes providing local memory to the downstream one of the plurality of ultra simple cores to store received streamed data.

3. A method as claimed in claim 2, wherein connecting includes providing a sequencer to the downstream one of the plurality of ultra simple cores to sequence received data.

4. A method as claimed in claim 3, wherein providing a sequencer includes providing a sequencer to sequence received streamed data.

5. A method as claimed in claim 4, wherein providing a sequencer includes providing an active sequencer.

6. A method as claimed in claim 5, wherein providing an active sequencer includes providing a sequencer memory and an execution memory.

7. A method as claimed in claim 4, wherein connecting includes providing delay buffers to the downstream one of the plurality of ultra simple cores to delay received streamed data.

8. A method as claimed in claim 7, wherein connecting includes providing an execution unit to the downstream one of the plurality of ultra simple cores to execute received streamed data.

9. A method as claimed in claim 8, wherein connecting includes connecting the execution unit to receive streamed data via the local memory.

10. A method as claimed in claim 1, further comprising connecting the plurality of ultra simple cores to exchange data with a base processor.

11. A method as claimed in claim 10, further including connecting the plurality of ultra simple cores and the base processor to shared storage.

12. A method of operating a plurality of ultra simple cores, comprising:
streaming to each downstream one of the plurality of ultra simple cores data from a respective at least one upstream one of the plurality of ultra simple cores, the data including at least one of information and an instruction, the information being at least one of an operand and flow control information,
wherein at least one of the respective at least one upstream one of the plurality of ultra simple cores streams at least one of an instruction and flow control information.

13. A method as claimed in claim 12, further including at least one of executing the streamed data and executing upon the streamed data at the downstream one of the plurality of ultra simple cores.

14. A method as claimed in claim 13, wherein executing includes branching.

15. A method as claimed in claim 14, wherein branching includes branching without interrupting the stream.

16. A system for configuring a plurality of ultra simple cores, comprising:
means for connecting each downstream one of the plurality of ultra simple cores to receive data streamed from a respective at least one upstream one of the plurality of ultra simple cores, the data including at least one of information and an instruction, the information being at least one of an operand and flow control information,
wherein at least one of the downstream one of the plurality of ultra simple cores is connected to receive at least one of an instruction and flow control information streamed from the respective at least one upstream one of the plurality of ultra simple cores.

17. A system as claimed in claim 16, wherein the means for connecting includes means for providing local memory to the downstream one of the plurality of ultra simple cores to store received streamed data.

18. A system as claimed in claim 17, wherein the means for connecting includes means for providing a sequencer to the downstream one of the plurality of ultra simple cores to sequence received data.

19. A system as claimed in claim 18, wherein the means for providing a sequencer includes means for providing a sequencer to sequence received streamed data.

20. A system as claimed in claim 19, wherein the means for connecting includes means for providing delay buffers to the downstream one of the plurality of ultra simple cores to delay received streamed data.

21. A system as claimed in claim 20, wherein the means for connecting includes means for providing an execution unit to the downstream one of the plurality of ultra simple cores to execute received streamed data.

22. A system as claimed in claim 21, wherein the means for connecting includes means for connecting the execution unit to receive streamed data via the local memory.

23. A system as claimed in claim 22, wherein the means for connecting includes means for creating a feedback delay.

24. A system as claimed in claim 23, wherein the means for creating a feedback delay includes means for configuring the sequencer to direct the execution unit to execute a plurality of instructions for a plurality of clock cycles.
